(19) United States
(12) Patent Application Publication
(10) Pub. No.: US 2024/0414747 A1
(43) Pub. Date: Dec. 12, 2024

(54) Secondary Cells Scheduling a Special Cell

(71) Applicant: Apple Inc., CUPERTINO, CA (US)

(72) Inventors: Haitong SUN, Saratoga, CA (US); Dawei ZHANG, Saratoga, CA (US); Seyed Ali Akbar FAKOORIAN, San Diego, CA (US); Sigen YE, San Diego, CA (US); Wei ZENG, Saratoga, CA (US); Yushu ZHANG, Beijing (CN)

(21) Appl. No.: 18/702,995

(22) PCT Filed: Nov. 5, 2021
(86) PCT No.: PCT/CN2021/129115

§ 371 Date: Apr. 19, 2024

(51) Int. Cl. H04W 72/51; H04L 27/26; H04W 72/25

(52) U.S. Cl. CPC H04W 72/51; H04L 27/26025; H04W 72/25

(57) ABSTRACT

A user equipment (UE) is configured to determine whether the UE supports a scheduling secondary cell (sSCell) scheduling a special cell (SpCell) and transmit a UE capability message indicating the UE supports an sSCell scheduling an SpCell, wherein the UE capability message comprises one of per band combination support, per feature set support or per UE support.

### BACKGROUND

A user equipment (UE) may connect to a variety of different networks or types of networks. When connected, the UE may be configured with a special cell (SpCell) and a secondary cell (SCell). It has been identified that it may be beneficial if both the SpCell and the SCell can schedule the SpCell. However, implementing this feature raises UE complexity concerns.

Additionally, because 5G new radio (NR) spectrum is difficult to obtain and expensive, operators have utilized dynamic spectrum sharing (DSS) so that 5G NR and long-term evolution (LTE) transmissions can coexist in the same spectrum. However, transmissions of the CORESETS for 5G communications may interfere with cell reference signals (CRS) transmissions on the LTE network.

Further, it has been identified that there may be control channel difficulty with Dynamic Spectrum Sharing (DSS). For instance, the NR control channel cannot rate match LTE CRS. Additionally, the NR control may be prevented from having a 3 symbol CORESET, and therefore impacts control coverage if the LTE and NR is slot synchronized and/or LTE has at least a 2 symbol Physical Downlink Control Channel (PDCCH).

Currently, there exists a limitation on Rel-15 NR cross carrier scheduling, wherein the SpCell (PCell in PCG (Primary Cell Group) or PSCell in SCG (Secondary Cell Group)) can only be scheduled by itself. The SCell can be scheduled by any cell, but only by a single cell. In Rel-17, an SCell may be configured to schedule a SpCell and is referred to as a sSCell. In order to support a SpCell capable of being scheduled by other cells, there is a need to address some design issues, especially relating to UE capability reporting.

### SUMMARY

Some exemplary embodiments are related to a processor of a user equipment (UE) configured to perform operations. The operations include determining whether the UE supports a scheduling secondary cell (sSCell) scheduling a special cell (SpCell) and transmitting a UE capability message indicating the UE supports an sSCell scheduling an SpCell, wherein the UE capability message comprises one of per band combination support, per feature set support or per UE support.

Other exemplary embodiments are related to a user equipment (UE) having a transceiver configured to communicate with a scheduling secondary cell (sSCell) and a special cell (SpCell) and a processor communicatively coupled to the transceiver and configured to perform operations comprising. The operations include determining whether the UE supports the sSCell scheduling the SpCell and transmitting a UE capability message indicating the UE supports an sSCell scheduling an SpCell, wherein the UE capability message comprises one of per band combination support, per feature set support or per UE support.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary base station according to various exemplary embodiments.

FIG. 4 shows an exemplary information element (IE) illustrating configurations for a scheduling secondary cell (sSCell) to schedule a Special Cell (SpCell) according to various exemplary embodiments.

FIG. 5 shows a signaling diagram showing a UE reporting capability information including whether the UE supports sSCell scheduling of a SpCell according to various exemplary embodiments.

### DETAILED DESCRIPTION

The exemplary embodiments may be further understood with reference to the following description and the related appended drawings, wherein like elements are provided with the same reference numerals. The exemplary embodiments relate to a deployment scenario in which both a special cell (SpCell) and a secondary cell (SCell) are capable of scheduling the SpCell. As will be described in more detail below, implementing this type of functionality provides a network operator with more flexibility with regard to scheduling and thus, may improve network performance. However, from the perspective of a user equipment (UE), multiple cells being able to schedule a single cell raises complexity concerns. The exemplary techniques described herein provide an adequate balance of network side scheduling flexibility and UE implementation complexity.

The exemplary embodiments are described with regard to a UE. However, reference to the term UE is merely provided for illustrative purposes. The exemplary embodiments may be utilized with any electronic component that is configured with the hardware, software, and/or firmware to exchange information (e.g., control information) and/or data with the network. Therefore, the UE as described herein is used to represent any suitable electronic device.

The exemplary embodiments are also described with regard to dynamic spectrum sharing (DSS) between a long term evolution (LTE) radio access technology (RAT) and 5G NR RAT. Those skilled in the art will understand that DSS generally refers to the deployment of multiple RATS in the same frequency bands and the dynamic allocation of spectrum resources between those RATS. DSS may enable a network carrier to deploy 5G NR on top of the spectrum already being used for LTE. However, when multiple RATS share the same frequency band, a collision may occur between the signals of the different RATS. This may cause performance degradation on the UE side and/or the network side for both LTE and 5G NR operations.

In addition, the exemplary embodiments are described with regard to a 5G New Radio (NR) network. However, reference to a 5G NR network is merely provided for illustrative purposes. The exemplary embodiments may be utilized with any network that implements the functionalities described herein.

To provide more flexibility to a 5G NR network using dynamic spectrum sharing (DSS) to schedule control data to be transmitted, according to some exemplary embodiments, cross carrier scheduling is used to support an SCell scheduling an SpCell.

In other exemplary embodiments, various clarifications may be made to the UE behavior based on the fact that an SCell may be used to schedule a SpCell.

According to still further exemplary embodiments, the UE indicates a capability of whether the UE supports an SCell scheduling a SpCell. The UE capability information may include various information to allow the network to understand the features which are supported by the UE. Each of these features will be described in greater detail below.

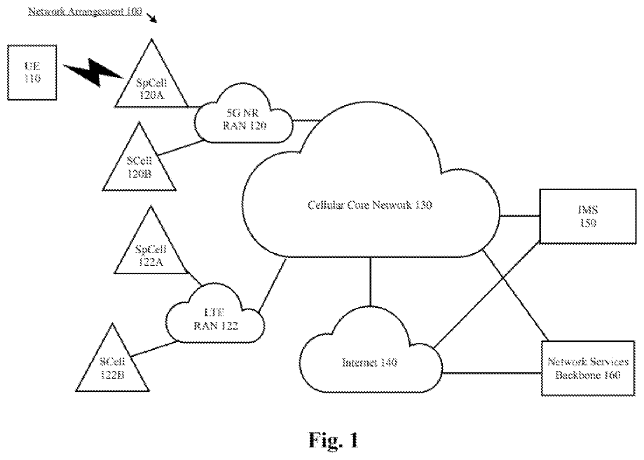

FIG. 1 shows an exemplary network arrangement 100 according to various exemplary embodiments. The exemplary network arrangement 100 includes a user equipment (UE) 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120 and a Long Term Evolution (LTE) RAN 122. However, the UE 110 may also communicate with other types of networks (e.g., 5G cloud RAN, a next generation RAN (NG-RAN), a legacy cellular network, a WLAN, etc.) and the UE 110 may also communicate with networks over a wired connection. With regard to the exemplary embodiments, the UE 110 may establish a connection with the 5G NR RAN 120 and/or the LTE RAN 122. Therefore, the UE 110 may have a 5G NR chipset to communicate with the NR RAN 120 and an LTE chipset to communicate with the LTE RAN 122.

The 5G NR-RAN 120 and the LTE-RAN 122 may be portions of cellular networks that may be deployed by cellular providers (e.g., Verizon, AT&T, T-Mobile, etc.). These networks 120 and 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

The UE 110 may connect to the 5G NR-RAN 120 via the gNB 120A and/or the gNB 120B. The gNBs 120A and 120B may be configured with the necessary hardware (e.g., antenna array), software and/or firmware to perform massive multiple in multiple out (MIMO) functionality. Massive MIMO may refer to a base station that is configured to generate a plurality of beams for a plurality of UE. During operation, the UE 110 may be within range of a plurality of gNBs. Reference to two gNBs 120A, 120B is merely for illustrative purposes. The exemplary embodiments may apply to any appropriate number of gNBs. Further, the UE 110 may communicate with the eNB 122A of the LTE-RAN 122 to transmit and receive control information used for downlink and/or uplink synchronization with respect to the 5G NR-RAN 120 connection.

Those skilled in the art will understand that any association procedure may be performed for the UE 110 to connect to the 5G NR-RAN 120 and/or the LTE-RAN 122. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific cell. For access to LTE services, a similar association procedure may be performed with the LTE RAN 122. However, as mentioned above, reference to the 5G NR-RAN 120 and the LTE-RAN 122 is merely for illustrative purposes and any appropriate type of RAN may be used.

The exemplary embodiments are described with regard to a scenario in which the UE 110 is configured with a primary cell group (PCG) and a secondary cell group (SCG). In the arrangement 100, the 5G NR RAN 120 includes a SpCell 120A and a SCell 120B. The LTE RAN 122 includes a SpCell 122A and a SCell 122B. The SpCells 120A, 122A may represent either a PCell of the PCG or a PSCell of the SCG. In this example, it may be considered that the SpCell 120A and zero or more of the SCells (e.g., gNB 120B, eNB 122B, etc.) may be configured as the PCG and the SpCell 122A and zero or more SCells (e.g., gNB 120, eNB 122B, etc.) may be configured as the SCG. However, the example shown in the arrangement 100 is merely provided for illustrative purposes and is not intended to limit the exemplary embodiments in any way. A cell group may be configured in a wide variety of different ways and may include any appropriate number of nodes. The exemplary techniques described herein apply to any scenario in which an SpCell and an SCell are configured to schedule the SpCell.

To provide a general example of dual connectivity (DC) within the context of the network arrangement 100, the UE 110 may be connected to both the 5G NR RAN 120 and the LTE RAN 122. However, reference to an independent 5G NR RAN 120 and an independent LTE-RAN 122 is merely provided for illustrative purposes. An actual network arrangement may include a RAN that includes architecture that is capable of providing both 5G NR RAT and LTE RAT services. For example, a next-generations radio access network (NG-RAN) (not pictured) may include a next generation Node B (gNB) that provides 5G NR services and a next generation evolved Node B (ng-eNB) that provides LTE services. The NG-RAN may be connected to at least one of the evolved packet core (EPC) or the 5G core (5GC). Thus, in one exemplary configuration, the UE 110 may achieve DC by establishing a connection to at least one cell corresponding to the 5G NR-RAN 120 and at least one cell corresponding to the LTE-RAN 122. In another exemplary configuration, the UE 110 may achieve DC by establishing a connection to at least two cells corresponding to the NG-RAN or any other type of similar RAN that supports DC. To provide another example of DC, the UE 110 may connect to one or more RANs that provide 5G NR services. For example, a NG-RAN may support multiple nodes that each provide 5G NR access, e.g., NR-NR DC. Similarly, the UE 110 may connect to a first RAN that provides 5G NR services and a second different RAN that also provides 5G NR services. Accordingly, the example of a single independent 5G NR-RAN 120 and a single independent LTE-RAN 122 is merely provided for illustrative purposes.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. It may include the EPC and/or the 5GC. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

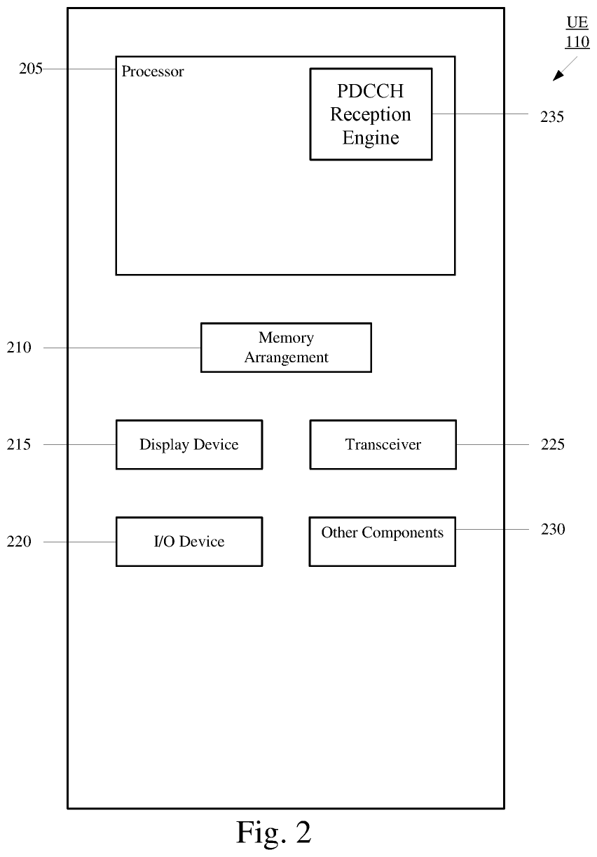

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a PDCCH reception engine 235. The PDCCH reception engine 235 may report the capability of the UE with respect to an SCell scheduling a SpCell and perform various operations related to PDCCH monitoring based in the UE capabilities.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

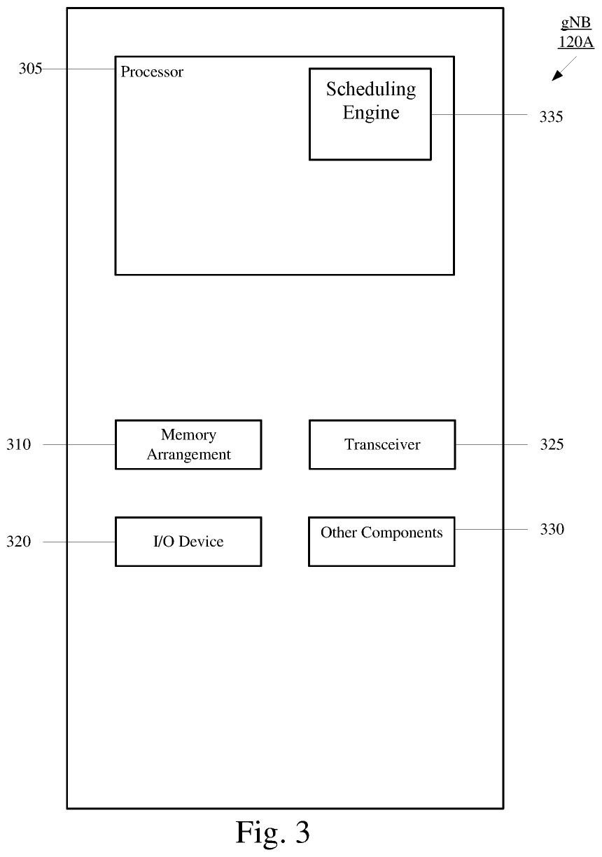

FIG. 3 shows an exemplary network base station, in this case gNB 120A, according to various exemplary embodiments. The gNB 120A may represent any access node of the 5G NR network through which the UE 110 may establish a connection. The gNB 120A illustrated in FIG. 3 may also represent the gNB 120B. In addition, the gNB 120A may represent a SpCell or an SCell.

The gNB 120A may include a processor 305, a memory arrangement 310, an input/output (I/O) device 320, a transceiver 325, and other components 330. The other components 330 may include, for example, a power supply, a data acquisition device, ports to electrically connect the gNB 120A to other electronic devices, etc.

The processor 305 may be configured to execute a plurality of engines of the gNB 120A. For example, the engines may include a scheduling engine 335 for performing operations including configuring one or more search spaces when both an SpCell and the SCell are configured to schedule control data transmissions on the SpCell and to configure the UE 110 to handle the deactivation or dormancy of the SCell. Examples of this process will be described in greater detail below.

The above noted engine being an application (e.g., a program) executed by the processor 305 is only exemplary. The functionality associated with the engines may also be represented as a separate incorporated component of the gNB 120A or may be a modular component coupled to the gNB 120A, e.g., an integrated circuit with or without firmware. For example, the integrated circuit may include input circuitry to receive signals and processing circuitry to process the signals and other information. In addition, in some gNBs, the functionality described for the processor 305 is split among a plurality of processors (e.g., a baseband processor, an applications processor, etc.). The exemplary aspects may be implemented in any of these or other configurations of a gNB.

The memory 310 may be a hardware component configured to store data related to operations performed by the UEs 110, 112. The I/O device 320 may be a hardware component or ports that enable a user to interact with the gNB 120A. The transceiver 325 may be a hardware component configured to exchange data with the UE 110 and any other UE in the system 100. The transceiver 325 may operate on a variety of different frequencies or channels (e.g., set of consecutive frequencies). Therefore, the transceiver 325 may include one or more components (e.g., radios) to enable the data exchange with the various networks and UEs.

The exemplary embodiments relate to a deployment scenario in which an SCell is configured to schedule subsequent SpCell communications. As a result, communication with the SpCell may be scheduled by the SpCell itself and/or the SCell (e.g., sSCell). When both cells are capable of scheduling the SpCell, both cells may transmit control information corresponding to the SpCell over the PDCCH. Consequently, the UE 110 may have to monitor the PDCCH for control information from two different cells. As indicated above, this increases complexity on the UE 110 side.

For LTE, control information such as CRS may be transmitted with high time and frequency domain density. A 5G NR UE may rate match around LTE CRS to perform PDCCH reception. For 5G NR, the PDCCH may include a CORESET which refers to a set of time and frequency resources used to carry DCI. The resource elements (REs) of the CORESET may be characterized in RE groups (REGs) and REG bundles. Each REG may consist of multiple REs (e.g., 2, 6, 12, etc.) in one orthogonal frequency division multiplexing (OFDM) symbol and each REG bundle may consist of multiple REGs. In accordance with DSS, the 5G NR control information is intended be invisible to LTE UEs.

The PDCCH may be carried by a particular number of control channel elements (CCEs). For example, the PDCCH may be carried by 1, 2, 4, 8, 16 or any other appropriate number of CCEs. Each CCE may consist of multiple REGs (e.g., 6 or any other appropriate amount). For PDCCH transmission, CCE-to-REG mapping may be performed. However, CCE-to-REG mapping is beyond the scope of the exemplary embodiments.

On the UE 110 side, PDCCH reception may include monitoring PDCCH candidates. In some embodiments, this may include blindly decoding multiple PDCCH candidates in a search space. PDCCH monitoring and reception of CORESETs may require the UE 110 to take on a certain complexity and energy cost in exchange for scheduling flexibility and lower overhead on the network side. By configuring the SpCell to be scheduled by the SpCell itself and the SCell, the complexity on the UE 110 side increases because more blind decodes (BDs) and CCEs may be configured but the flexibility on the network side increases because control channel signaling may be offloaded to the SCell.

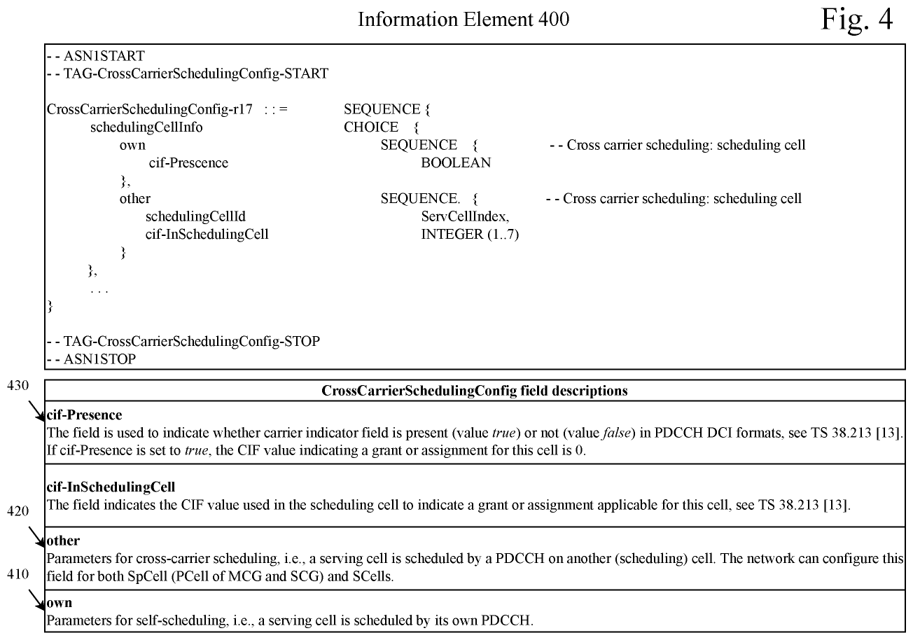

According to some exemplary embodiments, a new information element (IE) (e.g., CrossCarrierSchedulingConfig-r17) is introduced to allow cross carrier scheduling for support of an SCell scheduling an SpCell. FIG. 4 shows an exemplary information element (IE) 400 illustrating a configuration for a scheduling secondary cell (sSCell) to schedule a Special Cell (SpCell) according to various exemplary embodiments.

According to some exemplary embodiments, the “other” field 410 of the IE 400 may be configured for SpCell, including but not limited to an SpCell (e.g., a PCell of an PCG or an SCG) and/or a SCell of the PCG or the SCG. Thus, the enabling of cross carrier scheduling allows the SCells to schedule the SpCell(s). Those skilled in the art will understand that the CrossCarrierSchedulingConfig-r17 IE 400 may be configured for all the cells in the PCG and SCG. Various exemplary configurations of the CrossCarrierSchedulingConfig-r17 IE 400 for the different cells in the PCG and SCG will be described below.

According to some exemplary embodiments, both the “own” field 420 and the “other” field 410 may be configured in CrossCarrierSchedulingConfig-r17 IE 400. In these exemplary embodiments, both the “own” field 420 and the “other” field 410 may be configured only for the SpCell, including but not limited to, the primary cell of a PCG or SCG. Further, according to these exemplary embodiments, either the “own” field 420 or the “other” field 410 may be configured for the SCell(s), but not both.

According to other exemplary embodiments, when the “other” field 410 is configured for the SpCell, the UE 110 automatically assumes that the “own” field 420 is also configured for the corresponding SpCell. Additionally, according to these exemplary embodiments, the cif-Presence field 430 may be assumed to be configured to “true.”

In the above examples, it should be understood that the use of a specific name (e.g., CrossCarrierSchedulingConfig-r17) for the IE 400 to implement cross carrier scheduling is only exemplary and may be referred to using other names.

In other exemplary embodiments, various clarifications may be made to the UE behavior based on the fact that an SCell may be used to schedule a SpCell. For example, in some exemplary embodiments, the standards (e.g., Third Generation Partnership (3GPP) may be clarified to indicate that when the scheduled cell is an SCell, the UE can only be configured with one scheduling cell. It may also be clarified that when the scheduled cell is a SpCell in the PCG or the SCG, the UE can be configured with an optional feature that includes self-scheduling from a SpCell, or another sSCell may be used to schedule a SpCell.

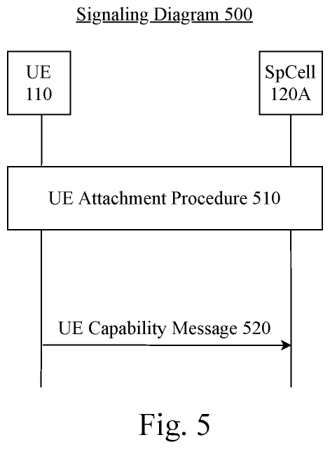

FIG. 5 shows a signaling diagram 500 showing a UE reporting capability information including whether the UE supports sSCell scheduling of a SpCell according to various exemplary embodiments. Those skilled in the art will understand that UEs report many capabilities to the network (e.g., 5G NR-RAN 120). According to some exemplary embodiments, the UE 110 that is connected to the 5G NR-RAN 120 may report its capabilities with respect to whether the UE supports sSCell scheduling of a SpCell.

In 510, the UE 110 performs an attach procedure 510 with the 5G NR-RAN 120 via the SpCell 120A. As described above, the UE 110 may perform any attach procedure to connect to the 5G NR-RAN 120 and the particular operations associated with the attach procedure (excluding the UE capability reporting) are outside the scope of the present disclosure. It should also be understood that if the attach procedure is an initial attach procedure the PCG and/or SCG may not yet be set up for the UE 110 and thus, reference to a SpCell 120A, may be premature, i.e., the UE may attach to a base station 120A that may later become an SpCell for a PCG and/or SCG for the UE 110.

In 520, the UE 110 may transmit a UE capability message 520 to the SpCell 120A indicating whether the UE 110 supports sSCell scheduling of a SpCell. The UE capability message 520 may include various information as to the type of support the UE 110 provides for sSCell scheduling of a SpCell. Examples of this information will be provided in greater detail below. It should be understood that UE capability message 520 may be performed as part of the UE attach procedure 510 or may be performed as part of another procedure such as a handover procedure, a radio resource configuration (RRC) procedure, etc.

Thus, at the completion of signaling 500, the network will understand whether the UE 110 supports sSCell scheduling of a SpCell and the type of support the UE 110 is providing. The following describes the various type of support the UE 110 may provide.

In some exemplary embodiments, the UE capability message may indicate whether the UE supports sSCell scheduling of a SpCell based on a per band combination (BC) basis, on a per feature set (FS) basis that includes per band per band combination support or on a per UE basis.

When the UE 110 indicates that the UE supports sSCell scheduling of a SpCell based on a per BC basis or a per UE basis, the UE 110 may also indicate additional information regarding that support. For example, in some exemplary embodiments, the UE 110 may report the supported sub-carrier spacing (SCS) for the sSCell. In these exemplary embodiments, the candidate SCS value may be, for example, {15 kHz, 30 kHz, or 60 kHz). A bitmap may be used to signal the supported SCS. Additionally, according to these exemplary embodiments, certain SCS may be a prerequisite of the other SCS, for example, 15 kHz is a pre-requisite of 30/60 kHz, and 30 kHz is a pre-requisite of 60 kHz.

In other exemplary embodiments, the UE 110 may report the supported sub-carrier spacing (SCS) for the SpCell. In these exemplary embodiments, the candidate value may be, for example, {15 kHz, 30 kHz, or 60 kHz) and bitmap may be used to signal these values. In addition, similar to the above-described exemplary embodiments, certain SCS may be a prerequisite of the other SCS, for example, 15 kHz is a pre-requisite of 30/60 kHz, and 30 kHz is a pre-requisite of 60 kHz.

In still further exemplary embodiments, the UE 110 may report the SCS for a list of one or multiple band pairs. According to these exemplary embodiments, in each band pair, the first band is the SpCell, the second band is the sSCell.

When the UE 110 indicates that the UE supports sSCell scheduling of a SpCell based on a per FS (per band per band combination) basis, the UE 110 may also indicate additional information regarding that support. For example, in some exemplary embodiments, the additional information may include whether the support/not support in each band indicates support of the corresponding band for the SpCell to be scheduled by any sSCell. For example, according to these exemplary embodiments, to support the sSCell in band 2 to schedule the SpCell in band 1, the UE 110 only needs to indicate support in band 1.

To provide a further example of the above, it may be considered that there is a band combination with 4 bands, band 1, band 2, band 3, band 4. The UE 110 reports support as follows, {1, 1, 0, 0}, e.g., there is support for the sSCell to schedule the SpCell in band 1 and band 2. In the above exemplary embodiments where support in each band indicates support of the corresponding band for the SpCell to be scheduled by any sSCell, would result in an SCell in any band being allowed to schedule a SpCell in band 1, e.g., band 2->band 1, band 3->band 1, band 4->band 1. Similarly, any band can schedule band 2, e.g., band 1->band 2, band 3->band 2, band 4->band 2.

In other exemplary embodiments, when per FS is used, support/not support in each band means the support of the corresponding band for the sSCell to schedule a SpCell. According to these exemplary embodiments, to support the sSCell in band 2 to schedule the SpCell in band 1, the UE 110 only needs to indicate support in band 2.

Again, to carry through with the example above of the UE 110 reporting a 4 band combination with support {1, 1, 0, 0}, would result in an SCell in band 1 allowing scheduling of an SpCell in any band, e.g., band 1->band 2, band 1->band 3, band 1->band 4. Similarly, an Scell in band 2 allows scheduling of an SpCell in any band, e.g., band 2->band 1, band 2->band 3, band 2->band 4.

According to still further embodiments, when per FS is used, support/not support in each band means the support of both the corresponding band to be sSCell to schedule SpCell and the corresponding band to be SpCell scheduled by any sSCell. According to these exemplary embodiments, to support sSCell in band 2 to schedule SpCell in band 1, the UE 110 would indicate support in both band 1 and band 2.

Again, to carry through with the example above of the UE 110 reporting a 4 band combination with support {1, 1, 0, 0}, would result in an SCell in band 1 to schedule an SpCell in band 2, e.g., band 1->band 2, and an Scell in band 2 to schedule an SpCell in band 1, e.g., band 2->band 1.

When the UE 110 indicates per FS support, the network may support each of the above exemplary embodiments. In this case, the UE 110 may indicate support for one or more of the above exemplary embodiments related to FS support.

In some exemplary embodiments, when the UE 110 reports whether the UE 110 supports sSCell scheduling of a SpCell, the UE 110 may further report how many total scheduled cells that can be scheduled by the sSCell. For example, according to some exemplary embodiments, the candidate value may be 2, 3, 4, 5, 6, 7, 8, etc. This capability may be extended to any cell that is configured to be a scheduling cell.

In some exemplary embodiments, when the UE 110 reports whether the UE 110 supports sSCell scheduling of a SpCell, the UE 110 may further report whether the UE 110 supports sSCell activation/deactivation. This feature may be either per UE or per BC.

In some exemplary embodiments, when the UE 110 reports whether the UE 110 supports sSCell scheduling of a SpCell, the UE 110 may further report whether the UE 110 supports sSCell dormancy. This feature may be either per UE or per BC.

In some exemplary embodiments, when the UE 110 reports the UE 110 supports sSCell scheduling of a SpCell, it may be assumed that the UE 110 only supports the basic PDCCH monitoring of feature groups (FG), e.g., FG3-1.

In some exemplary embodiments, when the UE 110 reports the UE 110 supports sSCell scheduling of a SpCell, the UE 110 may also report that the UE 110 supports advanced PDCCH monitoring for the sSCell, independently. For example, the UE 110 may report support for FG3-2: flexible CORESET time domain location, FG3-5: flexible CORESET time domain location, FG3-5a: span and gap based PDCCH monitoring, FG3-5b: span and gap based PDCCH monitoring, FG11-2 family: enhanced span and gap based PDCCH monitoring, etc.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above-described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor configured to:
determine whether a user equipment (UE) supports a scheduling secondary cell (sSCell) scheduling a special cell (SpCell); and
generate, for transmission, a UE capability message indicating the UE supports an sSCell scheduling an SpCell, wherein the UE capability message comprises one of per band combination support, per feature set support or per UE support.

2. The processor of claim 1, wherein the per feature set support comprises per band per band combination support.

3. The processor of claim 1, wherein, when the per band combination support or per UE support is indicated, the UE capability message further comprises a supported subcarrier spacing (SCS) of the sSCell or the SpCell.

4. The processor of claim 3, wherein the supported SCS comprises a candidate value of at least one of 15 kHz, 30 kHz, or 60 kHz.

5. The processor of claim 1, wherein, when the per band combination support or per UE support is indicated, the UE capability message further comprises a supported subcarrier spacing (SCS) based on a list of one or multiple band pairs.

6. The processor of claim 1, wherein, when the per feature set support is indicated, each supported band indicates the UE supports scheduling of the SpCell in the supported band by the sSCell in any corresponding band.

7. The processor of claim 1, wherein, when the per feature set support is indicated, each supported band indicates the UE supports scheduling of the SpCell in a corresponding band by the sSCell in a supported band.

8. The processor of claim 1, wherein, when the per feature set support is indicated, each supported band indicates the UE supports scheduling of the SpCell by the sSCell in each supported band.

9. The processor of claim 1, wherein the UE capability message further comprises a total number of cells which can be scheduled by the sSCell.

10. The processor of claim 9, wherein a candidate value indicating the total number of cells comprises one of 2, 3, 4, 5, 6, 7, or 8.

11. The processor of claim 1, wherein the UE capability message further indicates whether the UE supports sSCell activation or deactivation.

12. The processor of claim 1, wherein the UE capability message further indicates whether the UE supports sSCell dormancy.

13. The processor of claim 1, wherein the UE capability message further indicates whether the UE supports advanced Physical Downlink Control Channel (PDCCH) monitoring for the sSCell.

14. The processor of claim 13, wherein the monitoring comprises one of FG3-2: flexible CORESET time domain location, FG3-5: flexible CORESET time domain location, FG3-5a: span and gap based PDCCH monitoring, FG3-5b: span and gap based PDCCH monitoring, or FG11-2 family: enhanced span and gap based PDCCH monitoring.

15. A user equipment (UE), comprising:
a transceiver configured to communicate with a scheduling secondary cell (sSCell) and a special cell (SpCell); and
a processor communicatively coupled to the transceiver and configured to:
determine whether the UE supports the sSCell scheduling the SpCell; and
generate, for transmission by the transceiver, a UE capability message indicating the UE supports an sSCell scheduling an SpCell, wherein the UE capability message comprises one of per band combination support, per feature set support or per UE support.

16. The UE of claim 15, wherein the per feature set support comprises per band per band combination support.

17. The UE of claim 15, wherein, when the per band combination support or per UE support is indicated, the UE capability message further comprises a supported subcarrier spacing (SCS) of the sSCell or the SpCell.

18. The UE of claim 17, wherein the supported SCS comprises a candidate value of at least one of 15 kHz, 30 kHz, or 60 kHz.

19. The UE of claim 15, wherein, when the per band combination support or per UE support is indicated, the UE capability message further comprises a supported subcarrier spacing (SCS) based on a list of one or multiple band pairs.

20. The UE of claim 15, wherein, when the per feature set support is indicated, each supported band indicates the UE supports scheduling of the SpCell in the supported band by the sSCell in any corresponding band.

21-28. (canceled)
